(19) United States
(12) Patent Application Publication
(10) Pub. No.: US 2017/0109118 A1
(43) Pub. Date: Apr. 20, 2017

(54) CONTENT MONITORING WINDOW FOR WEARABLE ELECTRONIC DEVICES

(71) Applicant: Motorola Mobility LLC, Chicago, IL (US)

(72) Inventors: Roger W. Ady, Chicago, IL (US); Scott Debates, Crystal Lake, IL (US); Francois M. Dermu, San Mateo, CA (US)

(21) Appl. No.: 14/887,762

(22) Filed: Oct. 20, 2015

(51) Int. Cl. G06F 3/14; G06F 3/0486; G09G 5/12; G06F 3/0481; G06F 1/16; G06F 3/0484; G06F 3/0488

(52) U.S. Cl. CPC G06F 3/1454; G06F 3/04845; G06F 3/0486; G06F 3/04883; G06F 3/04817; G06F 1/163; G06F 3/04842; G09G 5/12; G09G 2370/02

(57) ABSTRACT

Establishing a communication link between a wearable device having a first display screen and a mobile device having a second display screen. A movable content selection window is provided on the first screen. A user's selection of a position for the window is received. The selected position for the window is sent over the communication link. Image data is received from the mobile device that is associated with a position on the second display screen corresponding to the selected position of the window. The image data is displayed on the wearable device.

### FIELD OF THE DISCLOSURE

The present disclosure relates generally to wearable electronic devices and, more particularly, to methods and apparatuses for providing a content monitoring window for wearable electronic devices.

### BACKGROUND OF THE DISCLOSURE

From time to time, an individual may have a desire or a need to monitor content on a mobile device. In some situations, the mobile device is not readily accessible, or it may be socially inappropriate for the individual to interact with the mobile device to obtain content updates of interest. Moreover, anxious monitoring of the mobile device can cause undesired battery drain since the display needs to be activated to show the items of interest.

Wearable devices are enjoying ever-increasing popularity. The terms “wearable technology”, “wearable devices”, and “wearables” all refer to electronic technologies or computers that are incorporated into items of clothing or accessories which can be worn on the body. Examples include smartwatches configured to run an operating system such as Android Wear™ or WatchOS™. Android Wear™ is a version of Google's Android™ operating system designed for smartwatches and other wearables.

Existing operating systems, such as Android Wear™ and WatchOS™, provide a feature by which a user is able to set up alerts and notifications for the wearable device. For example, Android Wear™ pairs a smartwatch or other wearable device with a mobile device running Android™ version 4.3 or newer, or iOS™ version 8.2 or newer, to enable a user to set up one or more notifications that are to be provided to the wearable device. However, this setup process may prove to be undesirably cumbersome, frustrating, and non-intuitive. A user is required to perform a separate setup procedure for each application from which an alert or a notification is desired. Moreover, the alert or notification may not include the specific content that the user needs or desires.

### BRIEF SUMMARY OF THE INVENTION

In at least some embodiments, the present invention relates to a method that includes establishing a communication link between a communication device and a remote device, wherein the communication device includes a first display screen; providing a movable content selection window on the first display screen, wherein the movable content selection window encompasses at least one area or region comprising a subset of the first display screen; receiving a user's selection of a position for the content selection window; retrieving image data that is associated with the selected position of the content selection window from an image memory buffer of the communication device; and sending the retrieved image data to the remote device over the communication link; wherein the communication device comprises a mobile device or a computer.

According to another set of embodiments, the present invention relates to a method that includes establishing a communication link between a wearable device having a first display screen, and a mobile device or a computer having a second display screen. The method further includes providing a movable content selection window on the first display screen, wherein the movable content selection window encompasses at least one area or region comprising a subset of the second display screen; receiving a user's selection of a position for the content selection window on the first display screen, wherein each of respective positions within the content selection window on the first display screen is associated with a corresponding position on the second display screen; sending the user's selected position for the content selection window over the communication link to the mobile device or to the computer; receiving a first set of image data from the mobile device or from the computer over the communication link, wherein the first set of image data is associated with a position on the second display screen that corresponds to the selected position of the content selection window; displaying a first set of contents comprising the received first set of image data on the first display screen for display on the wearable device; and updating the first set of contents of the content selection window by receiving a second set of image data from the mobile device or from the computer over the communication link and displaying the second set of image data.

Additionally, in at least some embodiments, the present invention relates to a mobile device that includes a processing mechanism operatively coupled to a display screen, an image memory buffer, and a communications network interface. The communications network interface is configured for providing a communication link between the mobile device and a wearable device. The processing mechanism is configured for causing a display of a movable content selection window on the display screen, wherein the movable content selection window encompasses at least one area or region comprising a subset of the display screen. The display screen is configured for receiving a user's selection of a position for the content selection window. The processing mechanism is configured for retrieving image data that is associated with the selected position of the content selection window from the image memory buffer. The processing mechanism is further configured for sending the retrieved image data over the communication network interface to the wearable device.

Additionally, in at least some embodiments, the present invention relates to a wearable device that includes a processing mechanism operatively coupled to a first display screen and a communications network interface. The communications network interface is configured for establishing a communication link between the wearable device and a mobile device or a computer having a second display screen. The processing mechanism is configured for causing a display of a movable content selection window on the first display screen, wherein the movable content selection window encompasses at least one area or region comprising a subset of a second display screen. The first display screen is configured for receiving a user's selection of a position for the content selection window, each of respective positions within the content selection window being associated with a corresponding position on the second display screen. The communications network interface is configured for sending the user's selected position for the content selection window to the mobile device or to the computer, and for receiving a first set of image data from the mobile device or from the computer, wherein the first set of image data is associated with a position on the second display screen that corresponds to the selected position of the content selection window on the first display screen. The processing mechanism is configured for causing a display of a first set of contents comprising a first image and corresponding to the received first set of image data on the first display screen for display on the wearable device. The processing mechanism is further configured for updating the first set of contents to a second set of contents by receiving a second set of image data from the mobile device or from the computer over the communication link, and causing a display of a second image corresponding to the second set of image data.

### BRIEF DESCRIPTION OF THE DRAWINGS

FIG. 1 is a flowchart setting forth an illustrative operational sequence by which a mobile device or a computer provides a content monitoring window for a wearable electronic device in accordance with a first set of exemplary embodiments.

FIG. 2 is a flowchart setting forth an illustrative operational sequence for providing a content monitoring window on a wearable electronic device in accordance with a second set of exemplary embodiments.

FIGS. 3A-3C together comprise a flowchart setting forth an illustrative operational sequence by which a mobile device or a computer provides a content monitoring window for a wearable electronic device using a panning command in accordance with a third set of exemplary embodiments.

FIG. 4 is a data flow diagram setting forth an illustrative flow of information by which a mobile device provides a content monitoring window for a wearable electronic device in accordance with a fourth set of exemplary embodiments.

FIG. 5 is a data flow diagram setting forth an illustrative flow of information by which a computer provides a content monitoring window for a wearable electronic device in accordance with a fifth set of exemplary embodiments.

FIG. 6 is a hardware block diagram showing an illustrative wearable device on which any of the operational sequences and data flows of FIGS. 1-5 may be performed in accordance with a sixth set of exemplary embodiments.

FIG. 7 is a hardware block diagram showing an illustrative mobile device on which any of the operational sequences and data flows of FIGS. 1-5 may be performed in accordance with a seventh set of exemplary embodiments.

FIG. 8 is a pictorial representation of an illustrative graphical user interface for providing a content monitoring window on a wearable device using a mobile device in accordance with an eighth set of exemplary embodiments.

FIG. 9 is a pictorial representation of an illustrative graphical user interface showing a content monitoring window on a wearable device in accordance with a ninth set of exemplary embodiments.

### DETAILED DESCRIPTION

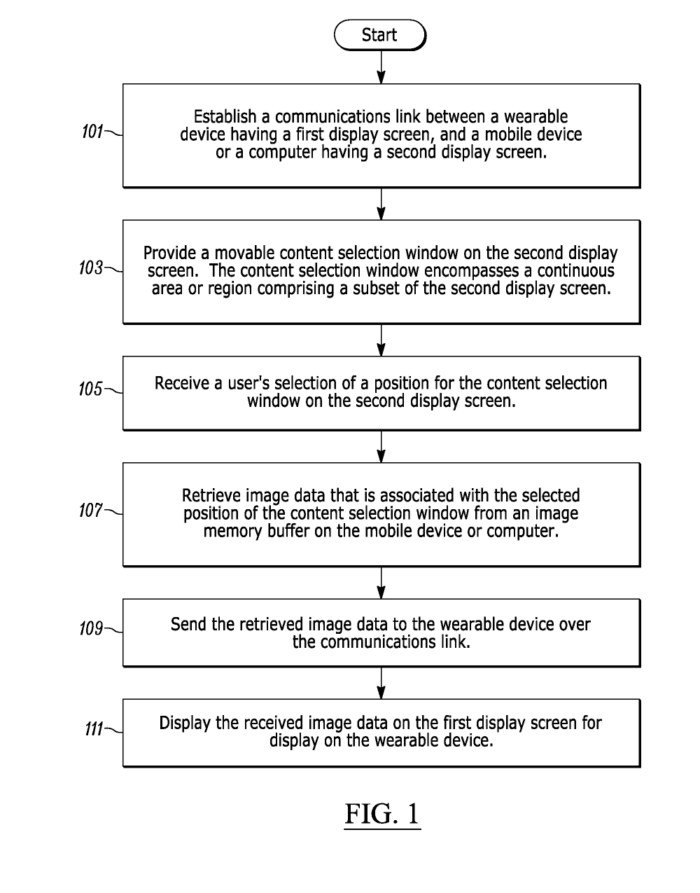

FIG. 1 is a flowchart setting forth an illustrative operational sequence by which a mobile device or a computer provides a content monitoring window for a wearable electronic device in accordance with a first set of exemplary embodiments. The procedure of FIG. 1 commences at block 101 where a communications link is established between a wearable device having a first display screen, and a mobile device or a computer having a second display screen. Illustratively, both the first and the second display screens are touch-sensitive and configured for accepting tactile inputs. However, in other embodiments, one or both of the first and second display screens need not be touch-sensitive.

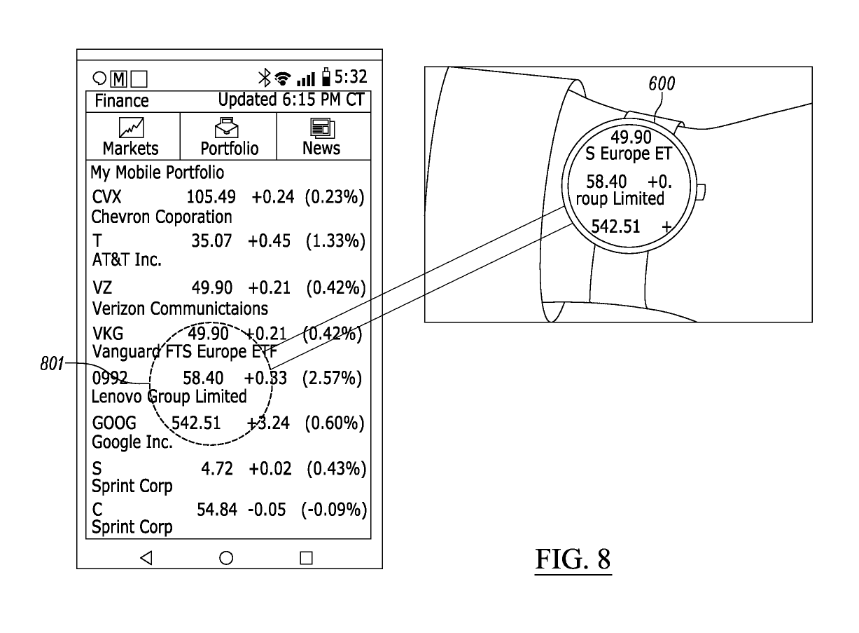

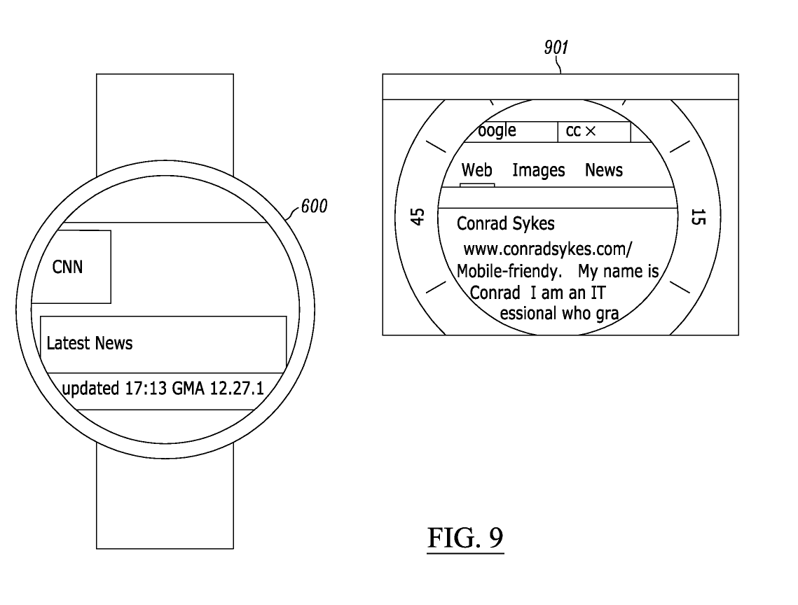

Next, at block 103, a movable content selection window is provided on the second display screen. The movable content selection window encompasses a continuous area or region comprising a subset of the second display screen. Illustratively, the movable content selection window may comprise a circular, oval, square, triangular, polygonal, tetrahedral, rectangular, or arbitrarily-shaped region that can be dropped and dragged to any of a plurality of positions within the second display screen. For purposes of illustration, the content selection window may be used to select a portion of a web site, an application readout, a settings screen, a short messaging service thread, or a captured image. Illustrative examples of movable content selection windows are described in greater detail hereinafter with reference to FIGS. 8 and 9.

Returning to FIG. 1, the operational sequence progresses to block 105 where a user's selection of a position for the content selection window is received on the second display screen. By way of example, the user may select a position for the content selection window that includes a desired item of content, such as a current stock price, a current bid price for an item on eBay™, a display of current weather conditions for one or more cities, or a periodically updated newsfeed. The desired item of content may, but need not, be displayed on a portion of an Internet web page, or on an active portion of a widget on a home screen.

Image data is retrieved that is associated with the selected position of the content selection window from an image memory buffer of the mobile device or computer (block 107). The retrieved image data is sent to the wearable device over the communications link (block 109). The received image data is displayed on the first display screen for display on the wearable device (block 111). Accordingly, the user is provided with easy access to desired content on the wearable device. Optionally, block 111 includes the step of resizing the received image data for the wearable device. The resizing may be performed at the wearable device, or alternatively, at the mobile device or computer.

In many real-world situations, accessing desired content on a wearable device provides certain advantages relative to accessing the content on a mobile device. Whereas it may be socially awkward or unsafe to access information on a mobile device, it is possible to quickly and discreetly access this information by simply glancing at a watch face on a wearable device. For example, a user may be driving and unable to safely activate functions on a touch screen of a mobile device, or the user may be attending an important dinner where it would be rude to manipulate a mobile device. At the same time, the user may wish to win an eBay™ auction that is ending at an inopportune time, or the user may wish to sell shares of a certain stock at a desired target price. In these types of situations, the amount of information that is needed is not great, but the process of accessing this information on a mobile device may be too tedious and time-consuming. The wearable device provides a discreet, user-friendly solution to the foregoing dilemma.

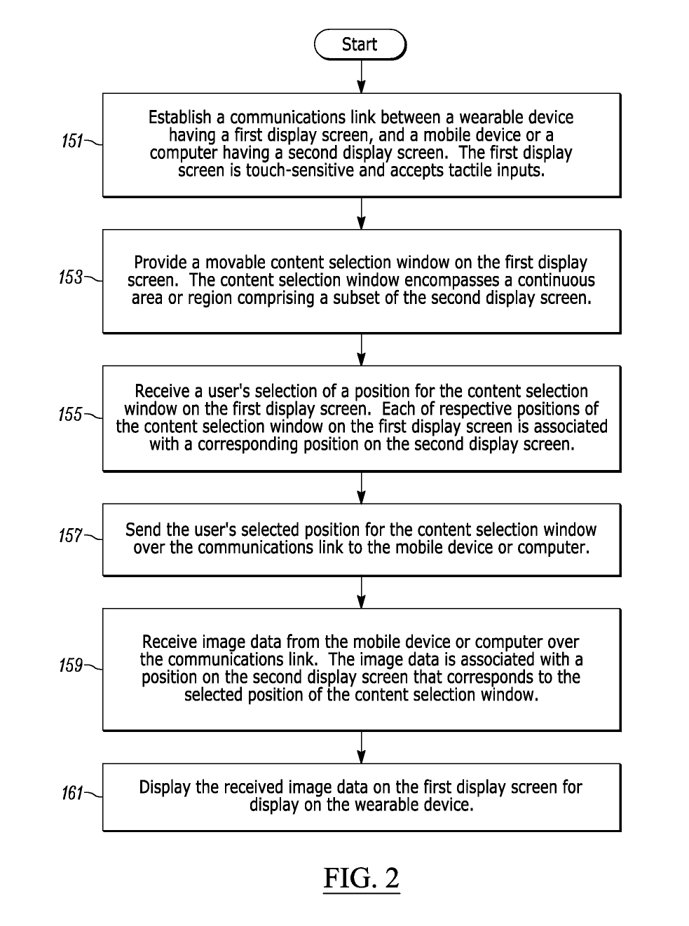

FIG. 2 is a flowchart setting forth an illustrative operational sequence for providing a content monitoring window on a wearable electronic device in accordance with a second set of exemplary embodiments. The operational sequence commences at block 151 where a communications link is established between a wearable device having a first display screen, and a mobile device or a computer having a second display screen. Illustratively, the first and second display screens are both touch-sensitive and configured for accepting tactile inputs. Next, at block 153, a movable content selection window is provided on the first display screen. The movable content selection window encompasses a continuous area or region comprising a subset of the second display screen.

The operational sequence progresses to block 155 where a user's selection of a position for the content selection window is received on the first display screen. Each of respective positions within the content selection window on the first display screen is associated with a corresponding position on the second display screen. The user's selected position for the content selection window is sent over the communications link to the mobile device or to the computer (block 157). Image data is received from the mobile device or from the computer over the communications link. The image data is associated with a position on the second display screen that corresponds to the selected position of the content selection window (block 159). The received image data is displayed on the first display screen for display on the wearable device (block 161). Optionally, block 161 includes the step of resizing the received image data for the wearable device. This resizing may, but need not, be performed by the wearable device.

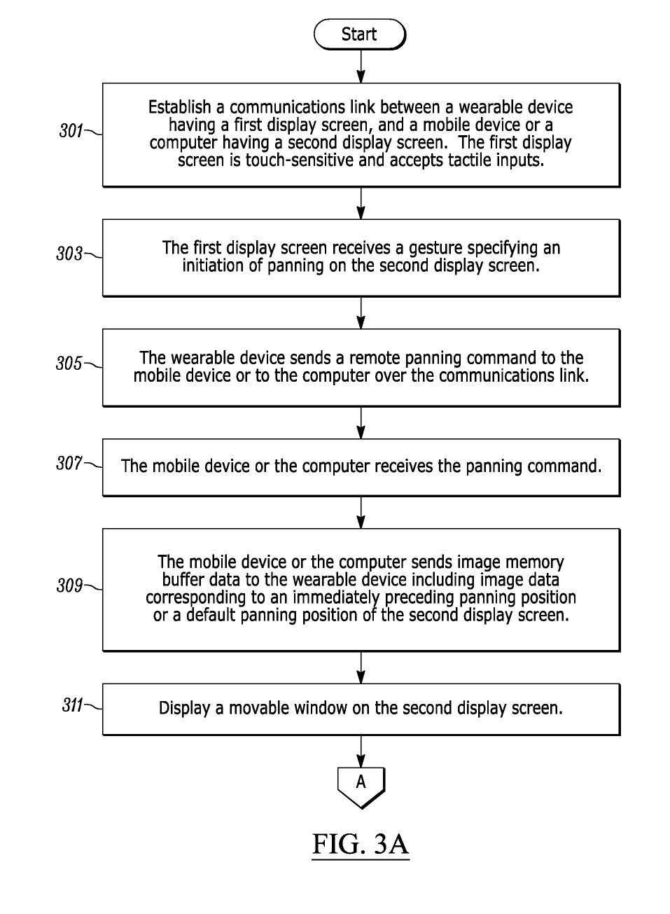

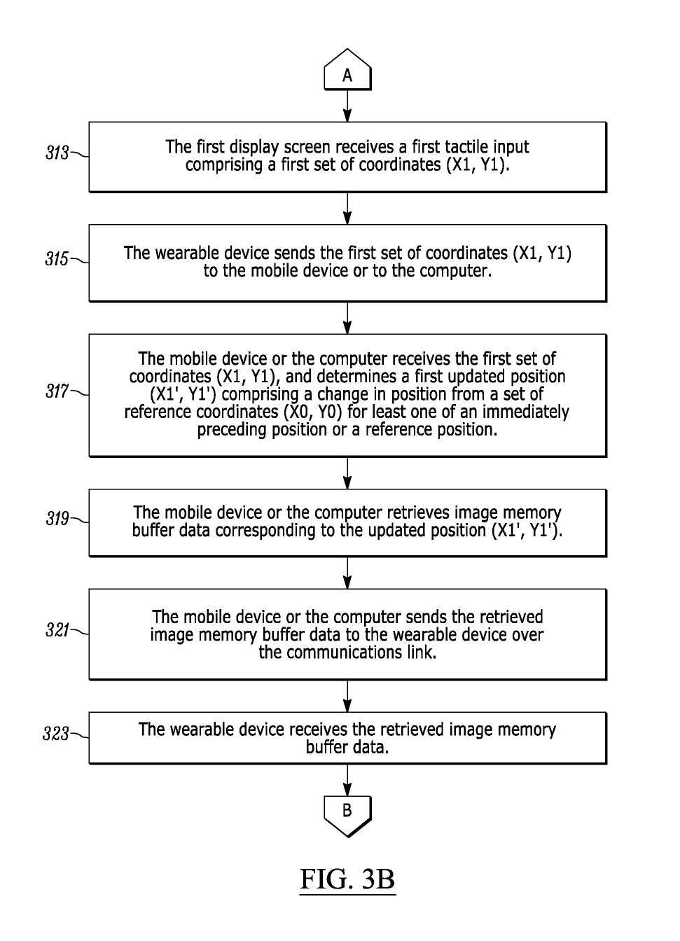

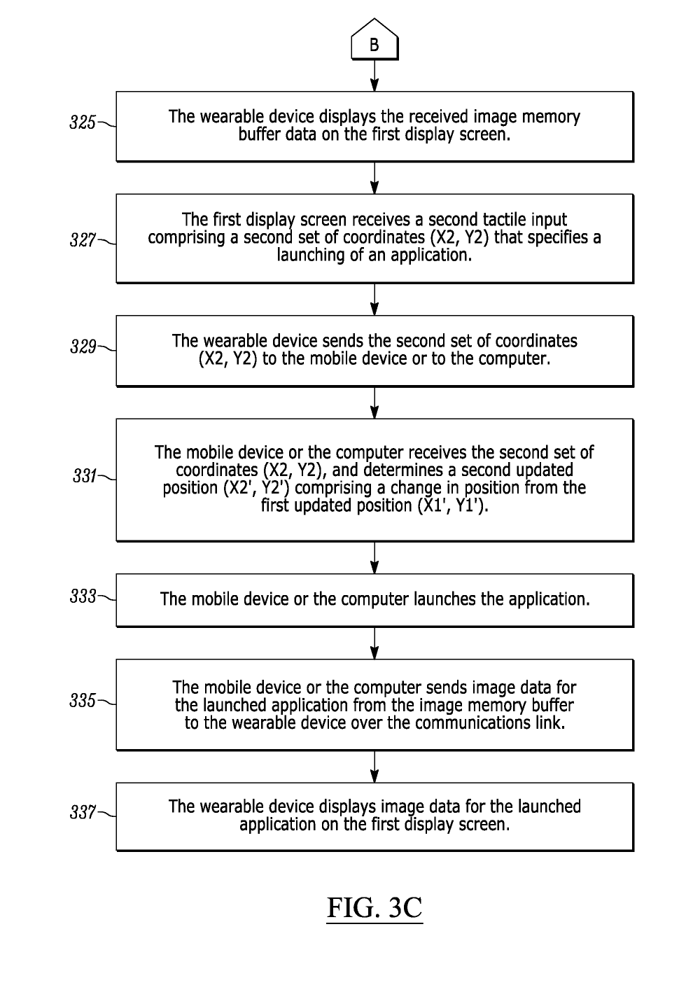

FIGS. 3A-3C together comprise a flowchart setting forth an illustrative operational sequence by which a mobile device or a computer provides a movable content monitoring window for a wearable electronic device using a panning command in accordance with a third set of exemplary embodiments. The operational sequence commences at block 301 of FIG. 3A where a communications link is established between a wearable device having a first display screen, and a mobile device or a computer having a second display screen. The first display screen is touch-sensitive and configured for accepting tactile inputs. Next, the first display screen receives a tactile gesture specifying an initiation of panning on the second display screen (block 303). A tactile gesture comprises one or more finger movements that are applied across a surface of the first display screen. An illustrative example of a tactile gesture is moving a finger to inscribe a circle, or a portion of a circle, along a perimeter of the surface of the first display screen.

The operational sequence progresses to block 305 (FIG. 3A), where the wearable device sends a remote panning command to the mobile device or to the computer over the communications link. Panning refers to scrolling, moving, sliding, or repositioning the movable content monitoring window. The mobile device or the computer receives the panning command (block 307). The mobile device or the computer sends image memory buffer data to the wearable device including image data corresponding to an immediately preceding panning position or to a default panning position of the second display screen. For example, a default panning position could be the center of the second display screen, or a corner of the second display screen, or the top center of the display screen, or an arbitrarily determined position on the second display screen.

Next, at block 311 (FIG. 3A), the movable content monitoring window is displayed on the second display screen. However, this step does not need to be performed if the mobile device is off or in a sleep mode. At block 313 (FIG. 3B), the first display screen receives a first tactile input comprising a first set of coordinates (X1, Y1). The wearable device sends the first set of coordinates (X1, Y1) to the mobile device or to the computer. (block 315). The mobile device or the computer receives the first set of coordinates (X1, Y1), and determines a first updated position (X1′, Y1′) comprising a change in position from a set of reference coordinates (X0, Y0) for at least one of the immediately preceding position or a reference position (block 317).

The operational sequence progresses to block 319 (FIG. 3B) where the mobile device or the computer retrieves image memory buffer data corresponding to the updated position (X1′, Y1′). The mobile device or the computer sends the retrieved image memory buffer data to the wearable device over the communications link (block 321). The wearable device receives the retrieved image memory buffer data (block 323). Next, the wearable device displays the received image memory buffer data on the first display screen (FIG. 3C, block 325).

The first display screen receives a second tactile input comprising a second set of coordinates (X2, Y2) that specifies a launching of an application (block 327). The wearable device sends the second set of coordinates (X2, Y2) to the mobile device or to the computer (block 329). The mobile device or the computer receives the second set of coordinates (X2, Y2), and determines a second updated position (X2′, Y2′) comprising a change in position from the first updated position (X1′, Y1′) (block 331). The mobile device or the computer then launches the application (block 333). The mobile device or the computer sends image data for the launched application from the image memory buffer to the wearable device over the communications link (block 335). The wearable device displays image data for the launched application on the first display screen (block 337).

The aforementioned operational sequence of FIGS. 1-3C merely provide sets of illustrative examples that are intended to be encompassed by the present disclosure. The present disclosure is intended to encompass numerous other manners of operation in addition to those specifically described previously. Numerous other examples of operation in accordance with the processes of FIGS. 1-3C, or variations of these processes, can be envisioned and are encompassed herein.

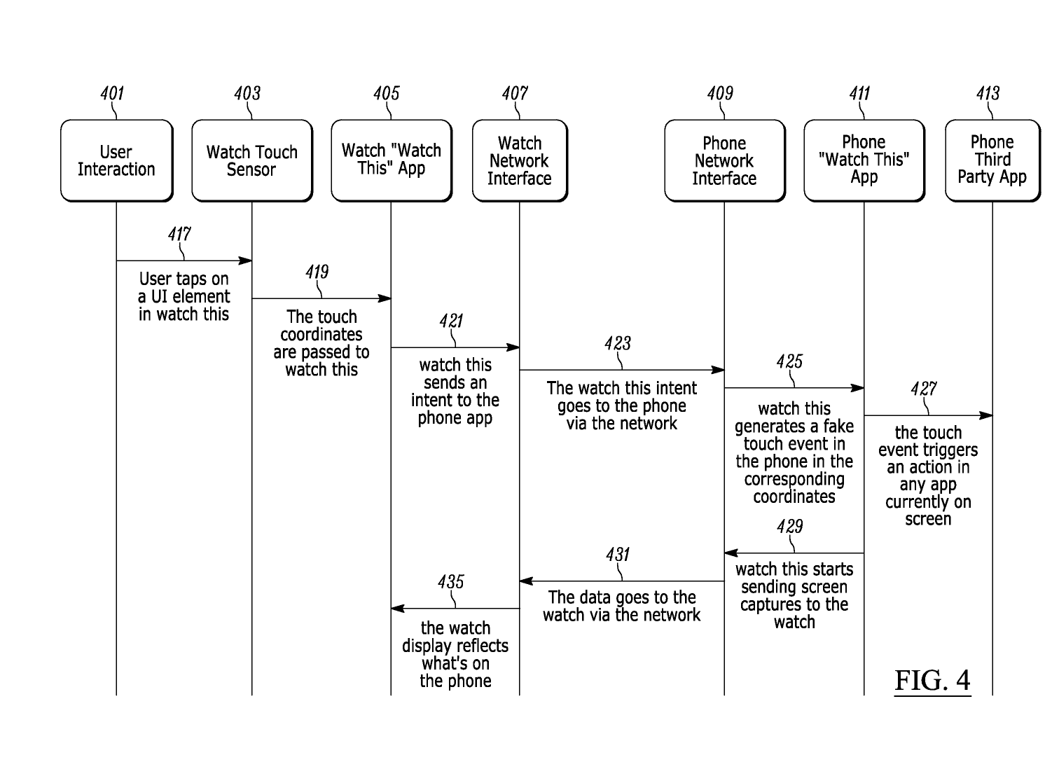

FIG. 4 is a data flow diagram setting forth an illustrative flow of information by which a mobile device provides a content monitoring window for a wearable electronic device in accordance with a fourth set of exemplary embodiments. In the example of FIG. 4, the wearable device is a watch including a watch touch sensor 403, a watch network interface 407, and a watch-based “watch this” application 405. The watch-based “watch this” application 405 comprises software for the watch implementing any of the procedures described previously in connection with FIGS. 1-3C. The mobile device is a mobile phone including a phone network interface 409, a phone third-party application 413, and a phone-based “watch this” application 411. The phone-based “watch this” application comprises software for the mobile phone implementing any of the procedures described previously in connection with FIGS. 1-3C.

The data flow of FIG. 4 commences at step 417 where a user interaction 401 is received at the watch touch sensor 403 when the user taps on a graphical user interface element at a set of touch coordinates in the watch-based “watch this” application 405. The set of touch coordinates are passed to the watch-based “watch this” application 405 at step 419. At step 421, the watch-based “watch this” application sends an intent message to a watch network interface 407. Illustratively, the watch network interface 407 is configured for communicating with a wireless communications network. The watch network interface 407 sends this intent message to the phone-based “watch this” application 411 via the phone network interface 409 at step 423. The phone-based “watch this” application 411 generates a simulated touch event in the phone at a second set of coordinates corresponding to the set of touch coordinates. Next, at step 427, the touch event triggers an action in any application that is currently on the screen of the mobile phone.

At step 429, the phone-based “watch this” application 411 triggers a content refresh and starts sending screen captures to the watch over the phone network interface 409. Note that the delivery of content may also be initiated at this step if a related service running in the background on the mobile phone, computer, or in the “cloud” detects a change in the selected content. The service may be provided with a sampling rate for monitoring changes, such as a user-definable sampling rate, to strike a desired balance between network and power usage, versus urgency. Then, at step 431, the watch network interface 407 receives these screen captures. The watch display reflects the display of the mobile phone at step 435. Note that the display on the mobile phone may not actually light up in order to save battery power on that device when it is simply servicing the “watch this” application.

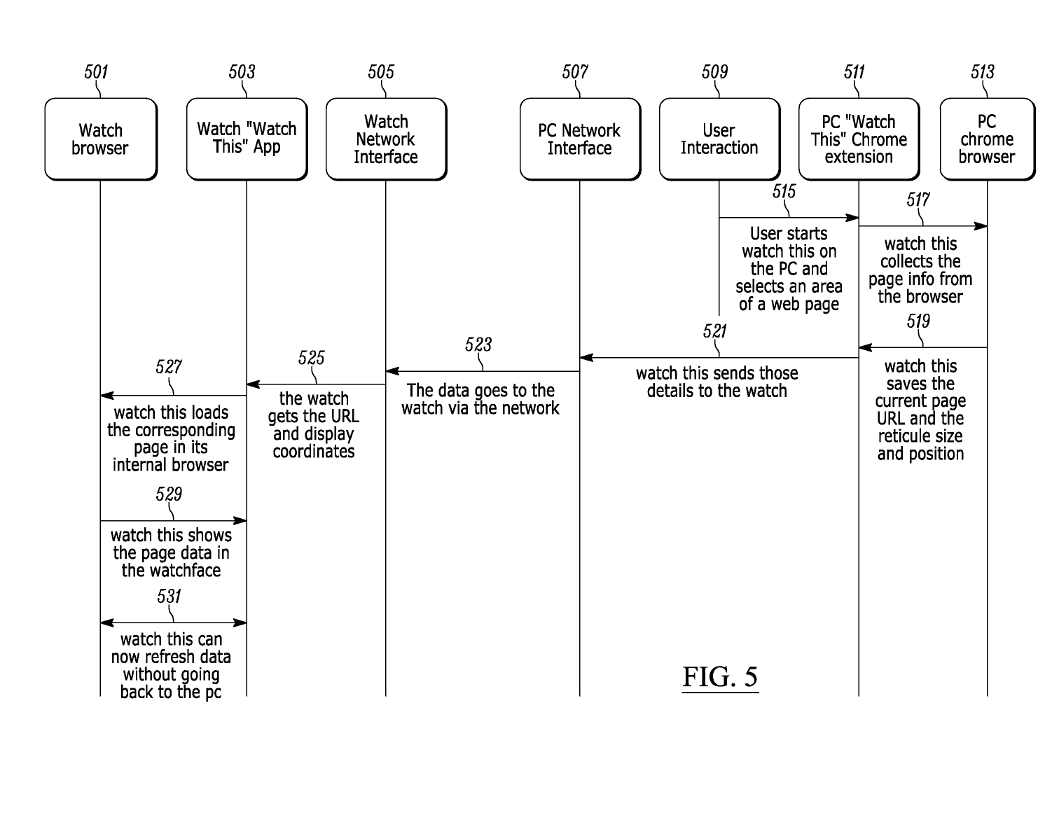

FIG. 5 is a data flow diagram setting forth an illustrative flow of information by which a computer provides a content monitoring window for a wearable electronic device in accordance with a fifth set of exemplary embodiments. In the example of FIG. 5, the wearable device is a watch including a watch browser 501, a watch network interface 505, and a watch-based “watch this” application 503. The watch-based “watch this” application 503 comprises software for the watch implementing any of the procedures described previously in connection with FIGS. 1-3C. For purposes of illustration, the computer is a personal computer (PC) or laptop computer including a PC network interface 507, a PC-based “watch this” Chrome™ browser extension 511, and a PC Chrome™ browser 513. The PC-based “watch this” Chrome™ browser extension 511 comprises software for the computer implementing any of the procedures described previously in connection with FIGS. 1-3C.

The data flow of FIG. 5 commences at step 515 where a user interaction 509 is received at the computer. The user interaction 509 specifies initiation of the PC-based “watch this” Chrome™ browser extension 511, and also specifies a selection of an area of a web page. Next, at step 517, the PC-based “watch this” Chrome™ browser extension 511 collects image data for the web page from the PC Chrome™ browser 513. At step 519, the PC-based “watch this” Chrome™ browser extension 511 saves a uniform resource locator (URL) for the web page, along with a reticule size and position for a movable content selection window. The PC-based “watch this” Chrome™ browser extension 511 sends the URL, along with the reticule size and position, to the PC network interface at step 521.

The URL, as well as the reticule size and position, are received by the watch network interface 505 at step 523. Next, at step 525, the watch-based “watch this” application 503 receives the URL, along with the reticule size and position. At step 527, the watch-based “watch this” application 503 loads the web page for the URL using the watch browser 501. The watch-based “watch this” application 503 displays the web page on the face of the watch at step 529. The watch can now refresh data without having to communicate with the computer over the watch network interface 505 and the PC network interface 507.

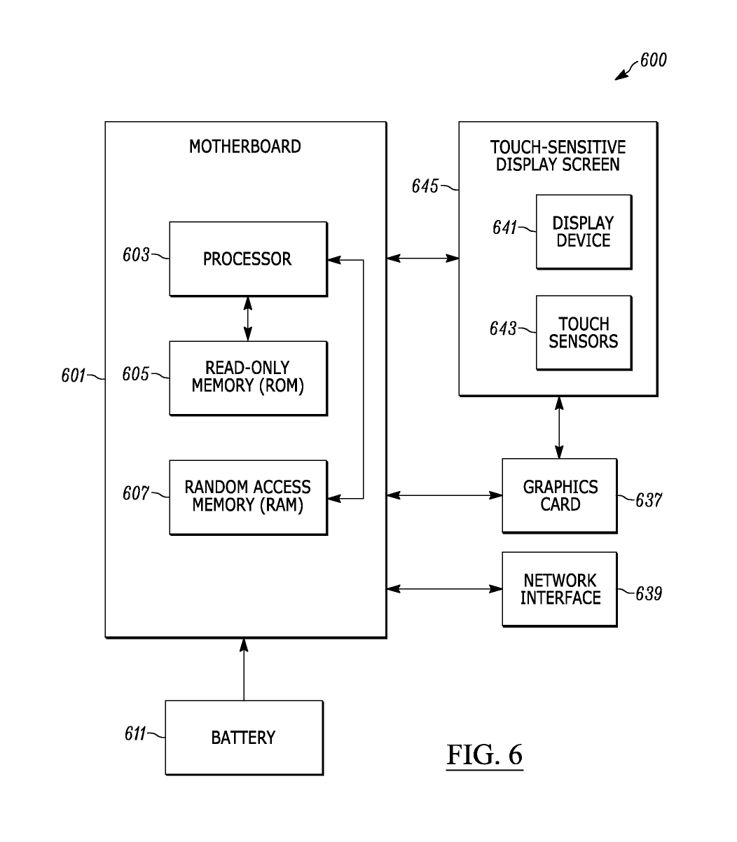

FIG. 6 is a hardware block diagram showing an illustrative wearable device 600 on which any of the operational sequences and data flows of FIGS. 1-5 may be performed in accordance with a sixth set of exemplary embodiments. A motherboard 601 includes a processor 603 operatively coupled to a read-only memory (ROM) 605 and a random access memory (RAM) 607. The processor 603 may comprise a microprocessor, a microcomputer, or an application-specific integrated circuit. The ROM 605 and RAM 607 can be used by the processor 603 to store and retrieve data. In some embodiments, the RAM 607 and/or the ROM 605 can be integrated with the processor 603 in a single device, such as a processing device including memory or processor-in-memory (PIM), although such a single device may typically have distinct portions/sections that perform the different processing and memory functions and that can be considered separate devices.

The wearable device 600 preferably includes a battery 611 for providing power to the other internal components while enabling the wearable device to be portable. A network interface 639 is operatively coupled to the motherboard 601. The network interface 639 may comprise a cellular transceiver, or a wireless local area network (WLAN) transceiver, or both. More particularly, the network interface 639 may be configured to conduct cellular data communications, such as 3G, 4G, 4G-LTE, etc., vis-à-vis cell towers (not shown), albeit in other embodiments, the network interface 639 can be configured instead or additionally to utilize any of a variety of other cellular-based communication technologies such as analog communications (using AMPS), digital communications (using CDMA, TDMA, GSM, iDEN, GPRS, EDGE, etc.), and/or next generation communications (using UMTS, WCDMA, LTE, IEEE 802.16, etc.) or variants thereof.

The network interface 639 may be configured to conduct Wi-Fi communications in accordance with the IEEE 802.11 (a, b, g, or n) standard with access points. In other embodiments, the network interface 639 can instead (or in addition) conduct other types of communications commonly understood as being encompassed within Wi-Fi communications such as some types of peer-to-peer (e.g., Wi-Fi Peer-to-Peer) communications. Further, in other embodiments, the network interface 639 can be replaced or supplemented with one or more other wireless transceivers configured for non-cellular wireless communications including, for example, wireless transceivers employing ad hoc communication technologies such as HomeRF (radio frequency), Home Node B (3G femtocell), Bluetooth and/or other wireless communication technologies such as infrared technology. Thus, the present disclosure is intended to encompass numerous embodiments in which any arbitrary number of one or more wireless transceivers employing any arbitrary number of one or more communication technologies are present.

The motherboard 601 is operatively coupled to a graphics card 637. The graphics card is configured for controlling and driving a touch-sensitive display screen 645. The touch-sensitive display screen 645 includes a display device 641 and touch sensors 643. The touch sensors 643 are configured for responding to tactile inputs. The touch-sensitive display screen 645 may, but need not, be implemented using a capacitive touchscreen panel, a resistive touchscreen panel, or a pressure-sensitive touchscreen panel.

For purposes of illustration, a capacitive touchscreen panel includes an insulating layer, such as glass, coated with a transparent conductor such as indium tin oxide (ITO). Some capacitive touchscreen panels are produced with ‘in-cell’ technology that eliminates a layer by building the capacitors inside the display itself. Since the human body is an electrical conductor, touching the surface of the touchscreen results in a distortion of the screen's electrostatic field, measurable as a change in capacitance. Any of a variety of technologies may be used to determine the location of the touch. The location is then sent to the processor 601 for processing.

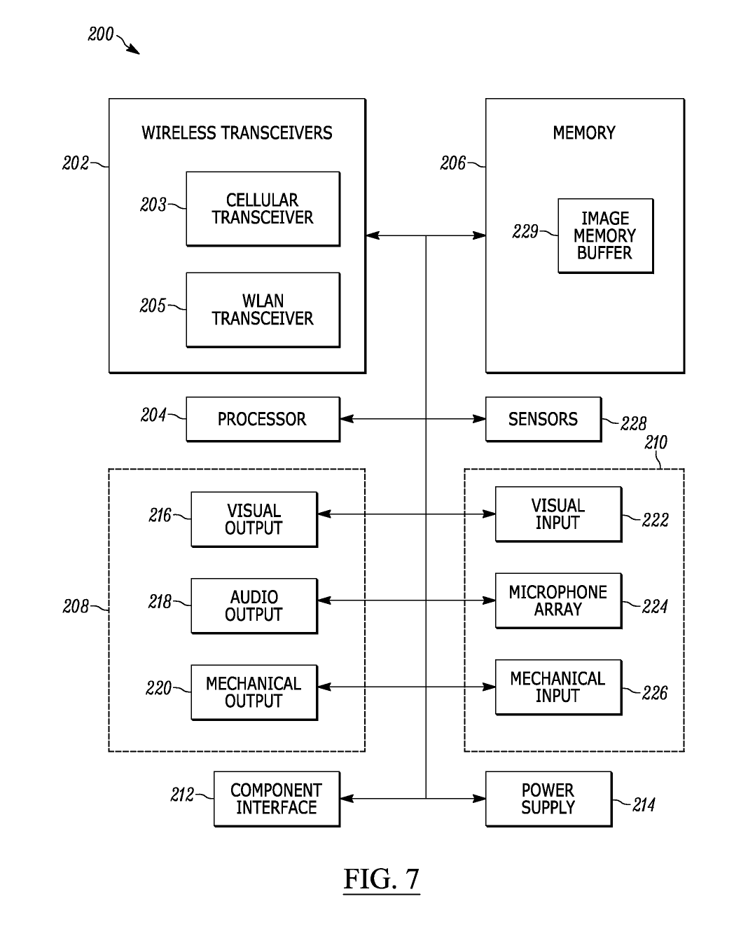

FIG. 7 is a hardware block diagram showing an illustrative mobile device 200 on which any of the operational sequences and data flows of FIGS. 1-5 may be performed in accordance with a seventh set of exemplary embodiments. The mobile device 200 (FIG. 7) is representative of any communication device that is operated by persons (or users) or possibly by other entities (e.g., other computers) desiring or requiring communication capabilities. In some embodiments, for example, the mobile device 200 may be any of a smartphone, a cellular telephone, a personal digital assistants (PDA), another type of handheld or portable electronic device, a headset, an MP3 player, a battery-powered device, a second wearable device or wristwatch, a radio, a navigation device, a laptop or notebook computer, a netbook, a pager, a PMP (personal media player), a DVR (digital video recorder), a gaming device, a game interface, a camera, an e-reader, an e-book, a tablet device, a navigation device with a video-capable screen, a multimedia docking stations, or another type of electronic mobile device.

As shown in FIG. 7, the illustrative mobile device 200 includes one or more wireless transceivers 202, a processor 204 (e.g., a microprocessor, microcomputer, application-specific integrated circuit, etc.), a memory 206, one or more output devices 208, and one or more input devices 210. The memory 206 includes an image memory buffer 229 for storing image data associated with a visual output 216 that may be provided to a display screen or other display device. For example, the image memory buffer 229 may store a set of one or more screen shots or screen captures for the display screen.

In at least some embodiments, a user interface is present that comprises one or more output devices 208, such as a display, and one or more input devices 210, such as a keypad or touch sensor. The mobile device 200 can further include a component interface 212 to provide a direct connection to auxiliary components or accessories for additional or enhanced functionality. The mobile device 200 preferably also includes a power supply 214, such as a battery, for providing power to the other internal components while enabling the mobile device to be portable. Some or all of the components of the mobile device 200 can be coupled to one another, and in communication with one another, by way of one or more internal communication links 232 (e.g., an internal bus).

In the present embodiment of FIG. 7, the wireless transceivers 202 particularly include a cellular transceiver 203 and a wireless local area network (WLAN) transceiver 205. More particularly, the cellular transceiver 203 is configured to conduct cellular communications, such as 3G, 4G, 4G-LTE, etc., vis-à-vis cell towers (not shown), albeit in other embodiments, the cellular transceiver 203 can be configured instead or additionally to utilize any of a variety of other cellular-based communication technologies such as analog communications (using AMPS), digital communications (using CDMA, TDMA, GSM, iDEN, GPRS, EDGE, etc.), and/or next generation communications (using UMTS, WCDMA, LTE, IEEE 802.16, etc.) or variants thereof.

The WLAN transceiver 205 may, but need not, be configured to conduct Wi-Fi communications in accordance with the IEEE 802.11 (a, b, g, or n) standard with access points. In other embodiments, the WLAN transceiver 205 can instead (or in addition) conduct other types of communications commonly understood as being encompassed within Wi-Fi communications such as some types of peer-to-peer (e.g., Wi-Fi Peer-to-Peer) communications. Further, in other embodiments, the WLAN transceiver 205 can be replaced or supplemented with one or more other wireless transceivers configured for non-cellular wireless communications including, for example, wireless transceivers employing ad hoc communication technologies such as HomeRF (radio frequency), Home Node B (3G femtocell), Bluetooth and/or other wireless communication technologies such as infrared technology. Thus, although in the present embodiment the mobile device 200 has two of the wireless transceivers 203 and 205, the present disclosure is intended to encompass numerous embodiments in which any arbitrary number of (e.g., more than two) wireless transceivers employing any arbitrary number of (e.g., two or more) communication technologies are present.

Exemplary operation of the wireless transceivers 202 in conjunction with others of the internal components of the mobile device 200 can take a variety of forms and can include, for example, operation in which, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceiver(s) 202 convey the modulated signals by way of wireless and (possibly wired as well) communication links to other devices such as a server and one or more content provider websites (as well as possibly to other devices such as a cell tower, access point, or another server or any of a variety of remote devices).

Depending upon the embodiment, the mobile device 200 may be equipped with one or more input devices 210, or one or more output devices 208, or any of various combinations of input devices 210 and output devices 208. The input and output devices 208, 210 can include a variety of visual, audio and/or mechanical outputs. For example, the output device(s) 208 can include one or more visual output devices 216 such as a liquid crystal display and light emitting diode indicator, one or more audio output devices 218 such as a speaker, alarm and/or buzzer, and/or one or more mechanical output devices 220 such as a vibrating mechanism. The visual output devices 216 can include, among other things, a video screen.

In addition, by example, the input devices 210 may include one or more sensors 228, or one or more audio input devices 224 such as a microphone, or more mechanical input devices 226 such as a flip sensor, keyboard, keypad, selection button, navigation cluster, touch pad, touchscreen, capacitive sensor, motion sensor, and switch. Actions that can actuate one or more of the input devices 210 can include not only the physical pressing/actuation of buttons or other actuators, but can also include, for example, opening the mobile device 200 (if the device can take on open or closed positions), unlocking the device, moving the device to actuate a motion, moving the device to actuate a location positioning system, and operating the device.

The mobile device 200 includes one or more of various types of sensors 228. The sensors 228 can include, for example, a proximity sensor which may be provided in the form of a light detecting sensor, an ultrasound transceiver or an infrared transceiver, or a touch sensor. The sensors 228 may also include a barometer which may be configured to determine a current altitude for the mobile device 200. The sensors 228 may also include a Global Positioning System (GPS) locator, a triangulation receiver for receiving signals from two or more radio frequency beacons, an accelerometer, a tilt sensor, a gyroscope, or any other information collecting device that can identify a current location or user-device interface (carry mode) of the mobile device 200. Although the sensors 228 are for the purposes of FIG. 7 considered to be distinct from the input devices 210, in other embodiments it is possible that one or more of the input devices 210 can also be considered to constitute one or more of the sensors 228 (and vice-versa).

Additionally, even though in the present embodiment the input devices 210 are shown to be distinct from the output devices 208, it should be recognized that in some embodiments one or more devices serve both as input device(s) and output device(s). For example, in embodiments where a touchscreen is employed, the touchscreen can be considered to constitute both a visual output device and a mechanical input device.

The memory 206 of the mobile device 200 can encompass one or more memory devices of any of a variety of forms (e.g., read-only memory, random access memory, static random access memory, dynamic random access memory, etc.), and can be used by the processor 204 to store and retrieve data. In some embodiments, the memory 206 can be integrated with the processor 204 in a single device (e.g., a processing device including memory or processor-in-memory (PIM)), albeit such a single device will still typically have distinct portions/sections that perform the different processing and memory functions and that can be considered separate devices.

The data that is stored by the memory 206 can include, but need not be limited to, operating systems, applications, and informational data, such as a database. Each operating system includes executable code that controls basic functions of the communication device, such as interaction among the various components included among the mobile device 200, communication with external devices via the wireless transceivers 202 and/or the component interface 212, and storage and retrieval of applications and data, to and from the memory 206.

In addition, the memory 206 can include one or more applications for execution by the processor 204. One such application is the operational sequence described previously in connection with FIGS. 1-3C. Each application can include executable code that utilizes an operating system to provide more specific functionality for the communication devices, such as file system service and the handling of protected and unprotected data stored in the memory 206 (FIG. 7). Informational data is non-executable code or information that can be referenced and/or manipulated by an operating system or application for performing functions of the communication device. One such application is a client application or applications which are stored in the memory 206 and configured for performing any of the methods and data flows described herein (or portions thereof) with reference to FIGS. 1-5.

The client application or applications are intended to be representative of any of a variety of client applications that can perform the same or similar functions on any of various types of mobile devices, such as mobile phones, tablets, laptops, etc. The client application or applications may comprise one or more software-based applications that operate on the processor 204 (FIG. 7) and that are configured to provide an interface between one or more input devices 210, or one or more output devices 208, or any of various combinations thereof. In addition, the client application or applications governs operation of one or more of the input and output devices 210, 208. Further, the client application or applications may be configured to work in conjunction with a visual interface, such as a display screen, that allows a user of the mobile device 200 to initiate various actions. The client application or applications can take any of numerous forms and, depending on the embodiment, be configured to operate on, and communicate with, various operating systems and devices. It is to be understood that various processes described herein as performed by the mobile device 200, such as any of the operational sequences and data flows of FIGS. 1-5, can be performed in accordance with operation of the client application or applications in particular, and/or other application(s), depending on the embodiment.

FIG. 8 is a pictorial representation of an illustrative graphical user interface for providing a content monitoring window on the wearable device 600 (FIGS. 6 and 8) using a mobile device 200 (FIGS. 7 and 8) in accordance with an eighth set of exemplary embodiments. A user has positioned a movable content selection window in the form of a reticule 801 over a stock price on an Internet web page displayed on the mobile device 200. The user wants to monitor a portion of the information on this web page using the wearable device 600, such that when she twists her wrist, she sees the updated price of her stock. In this illustrative example, the stock trades from 8 PM to midnight in the user's time zone. The user is on a dinner date but wants to put in a “buy” order if the stock price drops when the markets open.

FIG. 9 is a pictorial representation of an illustrative graphical user interface showing a content monitoring window 901 on a wearable device 600 in accordance with a ninth set of exemplary embodiments. In this illustrative example, the position of the content monitoring window 901 may be shifted or scrolled to include different portions of a web page or other image that is displayed on a mobile phone or computer. For example, the wearable device 600 displays an upper portion of a news feed from CNN™, and the content monitoring window 901 is then scrolled or shifted to a lower position on the news feed page to show information about a news item involving Conrad Sykes. The content monitoring window 901 is provided in the shape of a watch face.

When a user invokes the phone-based “watch this” application 411 (FIG. 4), the user is presented with the round watch-like reticule 801 (FIG. 8) on the mobile device 200 display screen. The user can move the reticule 801 on any page view or image displayed on the mobile device 200. Optionally, the mobile device 200 display screen accepts tactile commands for zooming or shrinking the image that is displayed on the mobile device such that the reticule 801 encompasses a desired portion of the image, and/or excludes undesired portions of the image.

The image data that is inscribed in the reticule 801 when the user lifts his or her finger is the image data that can then be monitored on the wearable device 600 (FIGS. 8 and 9). Every time that the wearable device is awakened, it refreshes the page and extracts an updated view of the windowed location as the watch face. Alternatively or additionally, the page content can be updated in response to an input received from a user. Alternatively or additionally, the page content can be automatically updated on a one-time, periodic, or repeated basis. For example, a mobile phone or computer may push updates to the wearable device in response to a section of the display screen on the mobile phone or computer changing. In its simplest form, this pushing of updates may be accomplished by periodically checking the page content of interest, and calculating if any of these pixels have changed between a previous capture and a current capture of a window on the display screen of the mobile phone or computer. Detecting a change in one or more of these pixels, or a change in at least a minimum number of pixels, would trigger an update of the display on the wearable device. The captured window could be on a web site, an application readout, a settings screen, a short messaging service (SMS) thread, or another captured image. Content could include, for purposes of illustration, the time until the next bus or train arrives at a stop, a stock price, a sports score, an eBay™ price for an ongoing auction, a step counter, the last window in an SMS thread or hangout/Instant Messaging (IM) thread, or a weather-related alert.

As shown in FIG. 9, pursuant to a set of further embodiments, the user can move, shift, adjust, or tweak the position of the reticule 801. This function may be used, for example, if the refreshed web page appears slightly shifted on the wearable device display or watch face. Likewise, the refreshed web page may appear shifted if an extra line of wrapped text is subtracted or added. This function may be activated, for example, by using a tactile gesture in the form of a two-finger sliding action that is applied to the wearable device. This function may also be useful if the user wants to move the window to monitor a different part of the same image or web page, such as the next line of a text thread, a different sports team score, or a different stock quote, on the same screen page, as was described previously in connection with FIG. 9. For example, a locally-stored page may be stored at the wearable device and used as a quick and convenient reference for locating the reticule, but after selection, the content should be updated and refreshed, and displayed on the wearable device.

Pursuant to yet another additional embodiment, another useful capability is to allow the user to perform an action or activate an icon displayed in the content monitoring window 901 (FIG. 9) using the watch touch-sensitive display screen as a proxy for touching a corresponding area of the display screen of the mobile device 200 (FIG. 8). Accordingly, an icon displayed in the content selection window of the display screen of the wearable device 600 (FIGS. 8 and 9) is configured for being activated by a tactile input applied to the display screen of the wearable device 600, without having to provide a tactile input to a corresponding area of the display screen of the mobile device 200 (FIG. 8). Likewise, from the standpoint of the mobile device 200, the display screen of the mobile device is configured for displaying an icon that is also displayed on the wearable device. The icon may be activated for initiating an application at the mobile device in response to a tactile input being applied to the wearable device, without having to provide a tactile input to the icon displayed on the mobile device.

Pursuant to yet another additional embodiment, for purposes of expediency, the reticule 801 (FIG. 8) may be positioned only over content on one of the many home screens in Android™, which would then exclude using the feature on web pages or application pages which can suffer from relentless ad-triggered reformatting. Home screen pages may include live widgets with information such as sports scores, weather, and stock prices, for example.

Although the content monitoring window 901 (FIG. 9) is representative of a round watch face, the watch face does not need to be round, but may be of a polygonal, oval, rectangular, trapezoidal, triangular, square, or arbitrarily determined shape. The reticule 801 (FIG. 8) may be configured to have a geometry matching that of the content monitoring window 901 (FIG. 9). Moreover, the content monitoring window 901 may be scaled to possibly allow for a pixel-by-pixel extraction from the mobile device 200 display (FIG. 8) to the content monitoring window 901 (FIG. 9) of the wearable device 600.

Pursuant to still another further embodiment, the content monitoring window 901 may flash on the wearable device 600 display, and then time out to include the watch hands superimposed on top of the content. This option may be appropriate if the always-on mode is being used. Alternatively or additionally, the content monitoring window 901 may revert back to the user's chosen default watch face scheme. Alternatively or additionally, the content monitoring window 901 may enter a higher contrast but dim power saving mode after sharing the update for a brief interval.

Pursuant to still another further embodiment, if the content displayed in the content monitoring window 901 is from a web page and the wearable device 600 has direct Internet connectivity, perhaps via a Wi-Fi connection, the user could just select a section of the page on the mobile device 200 (FIG. 8), and then the phone-based “watch this” application 411 (FIG. 4) would send the URL of the page and the specific area on the page the user selected over to the wearable device 600 (FIG. 9) and, from this point onwards, the wearable device would operate on its own without communicating with the mobile device 200 (FIG. 8).

It should be appreciated that one or more embodiment encompassed by the present disclosure are advantageous in one or more respects. Thus, it is specifically intended that the present disclosure not be limited to the embodiments and illustrations contained herein, but include modified forms of those embodiments including portions of the embodiments and combinations of elements of different embodiments as come within the scope of the following claims.

What is claimed is:

1. A method comprising:
establishing a communication link between a communication device and a remote device, wherein the communication device includes a first display screen;
providing a movable content selection window on the first display screen, wherein the movable content selection window encompasses at least one area or region comprising a subset of the first display screen;
receiving a user's selection of a position for the content selection window;
retrieving image data that is associated with the selected position of the content selection window from an image memory buffer of the communication device; and
sending the retrieved image data to the remote device over the communications link;
wherein the communication device comprises a mobile device or a computer.

2. The method of claim 1 wherein the movable content selection window comprises a circular, oval, square, triangular, polygonal, tetrahedral, or rectangular region that is configured for dropping and dragging to any of a plurality of positions within the first display screen.

3. The method of claim 1 further comprising configuring the first display screen to be touch-sensitive and to accept tactile inputs.

4. The method of claim 3 further comprising:
providing the remote device with a second display screen that is touch-sensitive and configured to accept tactile inputs; and
displaying an icon in the content selection window of the first display screen, wherein the icon is configured for being activated by a tactile input applied to the second display screen, without having to provide a tactile input to a corresponding area of the first display screen.

5. The method of claim 1 further comprising the content selection window selecting at least one of: a portion of a web site, an application readout, a settings screen, a short messaging service thread, or a captured image.

6. A method comprising:
establishing a communication link between a wearable device having a first display screen, and a mobile device or a computer having a second display screen;
providing a movable content selection window on the first display screen, wherein the movable content selection window encompasses at least one area or region comprising a subset of the second display screen;
receiving a user's selection of a position for the content selection window on the first display screen, wherein each of respective positions within the content selection window on the first display screen is associated with a corresponding position on the second display screen;
sending the user's selected position for the content selection window over the communication link to the mobile device or to the computer;
receiving a first set of image data from the mobile device or from the computer over the communication link, wherein the first set of image data is associated with a position on the second display screen that corresponds to the selected position of the content selection window;
displaying a first set of contents comprising the received first set of image data on the first display screen for display on the wearable device; and
updating the first set of contents to a second set of contents by receiving a second set of image data from the mobile device or from the computer over the communication link and displaying the second set of image data.

7. The method of claim 6 further comprising configuring the movable content selection window as a circular, oval, square, triangular, polygonal, tetrahedral, or rectangular region, and configuring the first display screen to have a circular, oval, square, triangular, polygonal, tetrahedral, or rectangular geometry corresponding to the movable content selection window.

8. The method of claim 6 further comprising configuring the first display screen to be touch-sensitive and to accept tactile inputs.

9. The method of claim 8 further comprising:
configuring the second display screen to be touch-sensitive and to accept tactile inputs; and
displaying an icon in the content selection window of the first display screen, wherein the icon is configured for being activated by a tactile input applied to the first display screen, without having to provide a tactile input to a corresponding area of the second display screen.

10. The method of claim 6 further comprising the content selection window selecting at least one of: a portion of a web site, an application readout, a settings screen, a short messaging service thread, or a captured image.

11. A mobile device comprising:
a processing mechanism operatively coupled to a display screen, an image memory buffer, and a communications network interface;
the communications network interface being configured for providing a communication link between the mobile device and a wearable device;
the processing mechanism being configured for causing a display of a movable content selection window on the display screen, wherein the movable content selection window encompasses at least one area or region comprising a subset of the display screen;
the display screen being configured for receiving a user's selection of a position for the content selection window;
the processing mechanism being configured for retrieving image data that is associated with the selected position of the content selection window from the image memory buffer, and further being configured for sending the retrieved image data over the communication network interface to the wearable device.

12. The mobile device of claim 11 wherein the movable content selection window comprises a circular, oval, square, triangular, polygonal, tetrahedral, or rectangular region that is configured for dropping and dragging to any of a plurality of positions within the display screen.

13. The mobile device of claim 11 wherein the display screen is further configured to be touch-sensitive and to accept tactile inputs.

14. The mobile device of claim 13 wherein the display screen is further configured for displaying an icon that is also displayed on the wearable device, such that the icon is activated to initiate an application at the mobile device in response to a tactile input being applied to the wearable device, without having to provide a tactile input to the icon displayed on the mobile device.

15. The mobile device of claim 11 wherein the content selection window is configured for selecting at least one of: a portion of a web site, an application readout, a settings screen, a short messaging service thread, or a captured image.

16. A wearable device comprising:
a processing mechanism operatively coupled to a first display screen and a communications network interface;
the communications network interface being configured for establishing a communication link between the wearable device and a mobile device or a computer having a second display screen;
the processing mechanism being configured for causing a display of a movable content selection window on the first display screen, wherein the movable content selection window encompasses at least one area or region comprising a subset of a second display screen;
the first display screen being configured for receiving a user's selection of a position for the content selection window, each of respective positions within the content selection window being associated with a corresponding position on the second display screen;
the communications network interface being configured for sending the user's selected position for the content selection window to the mobile device or to the computer, and for receiving a first set of image data from the mobile device or from the computer, wherein the first set of image data is associated with a position on the second display screen that corresponds to the selected position of the content selection window on the first display screen;
the processing mechanism being configured for causing a display of a first set of contents comprising a first image and corresponding to the received first set of image data on the first display screen for display on the wearable device; and
the processing mechanism being configured for updating the first set of contents to a second set of contents by receiving a second set of image data from the mobile device or from the computer over the communication link, and causing a display of a second image corresponding to the second set of image data.

17. The wearable device of claim 16 wherein the movable content selection window comprises a circular, oval, square, triangular, polygonal, tetrahedral, or rectangular region, and the first display screen is configured to have a circular, oval, square, triangular, polygonal, tetrahedral, or rectangular geometry corresponding to the movable content selection window.

18. The wearable device of claim 16 wherein the first display screen is further configured to be touch-sensitive and to accept tactile inputs.

19. The wearable device of claim 16 wherein an icon is displayed in the content selection window of the first display screen, and wherein the icon is configured for being activated by a tactile input applied to the first display screen, without having to provide a tactile input to a corresponding area of the second display screen.

20. The wearable device of claim 16 wherein the content selection window is configured for selecting at least one of: a portion of a web site, an application readout, a settings screen, a short messaging service thread, or a captured image.
